(19) United States
(12) Patent Application Publication
(10) Pub. No.: US 2012/0019852 A1
(43) Pub. Date: Jan. 26, 2012

(54) PRINTING APPARATUS, METHOD FOR CONTROLLING PRINT QUALITY, AND STORAGE MEDIUM STORING INSTRUCTIONS FOR SAME

(75) Inventor: Takehiro Ito, Tokyo (JP)

(73) Assignee: CANON KABUSHIKI KAISHA, Tokyo (JP)

(21) Appl. No.: 13/188,311

(22) Filed: Jul. 21, 2011

(30) Foreign Application Priority Data
Jul. 26, 2010 (JP) 2010-166863

(51) Int. Cl. G06K 15/00

(52) U.S. Cl. 358/1.13

(57) ABSTRACT

A printing apparatus includes, a printing unit to execute printing based on first image data, a reading unit to read a sheet on which the printing has been executed to generate second image data, a determination unit to determine whether a printing failure has occurred on the sheet by comparing the first image data with the second image data, and a changing unit to change a determination method used for determining whether the printing failure has occurred. The determination unit executes determination based on the determination method changed by the changing unit. A display unit displays a result of the determination executed by the determination unit using the changed determination method.

### BACKGROUND OF THE INVENTION

1. Field of the Invention

The present invention relates to a printing apparatus, a method for controlling the print quality of the apparatus. An embodiment of the present invention also relates to a storage medium storing instructions for implementing the method.

2. Description of the Related Art

A conventional image forming apparatus may inspect a print product according to a set threshold values, and can perform reprinting (recovery printing) when there is a printing failure. The conventional image forming apparatus and recovery printing will be referred to as conventional technology 1.

Japanese Patent Application Laid-Open No. 2006-254106 an image processing technique that enables a user to preview color reproducibility of a print product to be output. To that end, an image forming apparatus transmits an image having failed to be color-reproduced by simulation on printing conditions to a client personal computer (PC) each time the user changes the printing conditions. This will be referred to as conventional technology 2.

However, in the above-described conventional technology 1, the threshold value to inspect the print product needs to be adjusted to a desired inspection level according to a printing purpose. It is therefore very difficult for the user to determine to what level the user must set the threshold value. The threshold value to inspect the print product may be set for each type of printing such as monochrome or color printing, thus adjustment of the threshold value may be cumbersome and complicated. When the threshold value is not set to an appropriate level, the print product may be processed as a printing failure more than necessary, creating a possibility that print products of satisfactory quality may be discarded while print products of quality to be discarded as printing failures may be processed as good prints.

In the conventional technology 2, even when the user changes the printing conditions to convert a reproduction failure area to a reproducible area in simulation, an actual print product may become a defective image in actual printing. For example, blurring occurs due to insufficient adhesion of a print agent such as toner to a print medium or conversely blotting occurs due to excessive adhesion of the print agent to the print medium, thereby causing the real print to become a defective image.

### SUMMARY OF THE INVENTION

The present invention is directed to a mechanism that enables a user to easily adjust an inspection threshold value corresponding to an inspection level desired by the user while viewing an actual print image.

According to an aspect of the present invention, a printing apparatus includes a printing unit configured to execute printing based on first image data, a reading unit configured to read a sheet on which the printing has been executed to generate second image data, a determination unit configured to determine whether a printing failure has occurred on the sheet by comparing the first image data with the second image data, a display unit configured to display a result of determination executed by the determination unit, and a changing unit configured to change a threshold value used for determining whether the printing failure has occurred by the determination unit after the display unit has displayed the result of the determination, wherein the determination unit executes, if the changing unit changes the threshold value, determination again based on the changed threshold value, and the display unit displays a result of the determination executed by the determination unit using the changed threshold value.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of an inspection system to which an image forming apparatus according to an exemplary embodiment of the present invention can be applied.

FIG. 2 illustrates an example of a schematic control configuration of the inspection system.

FIG. 3 illustrates an image of a one-line area where an image reading unit of an inspection unit reads a printed sheet.

FIGS. 4A to 4C illustrate matching ratios between print product read data and reference data, and an inspection threshold value.

FIG. 5 illustrates an image of threshold value adjustment to determine an inspection level.

FIG. 6 illustrates an image of threshold value adjustment to determine an inspection level.

FIG. 7 illustrates an image of threshold value adjustment to determine an inspection level.

FIG. 8 illustrates an image of threshold value adjustment to determine an inspection level.

FIG. 9 illustrates an image of threshold value adjustment to determine an inspection level.

FIG. 10 illustrates an image of threshold value adjustment to determine an inspection level.

FIG. 11 illustrates an image of threshold value adjustment to determine an inspection level.

FIG. 12 illustrates an image of threshold value adjustment to determine an inspection level.

FIGS. 13A and 13B illustrate images of threshold value adjustment to determine inspection levels.

FIG. 14 is a flowchart illustrating an example of threshold value adjustment processing in the inspection system according to the present exemplary embodiment.

FIG. 15 is a flowchart illustrating an example of threshold value adjustment processing in the inspection system according to the present exemplary embodiment.

FIG. 16 illustrates a list screen of inspection determination results.

### DESCRIPTION OF THE EMBODIMENTS

Various exemplary embodiments, features, and aspects of the invention will be described in detail below with reference to the drawings.

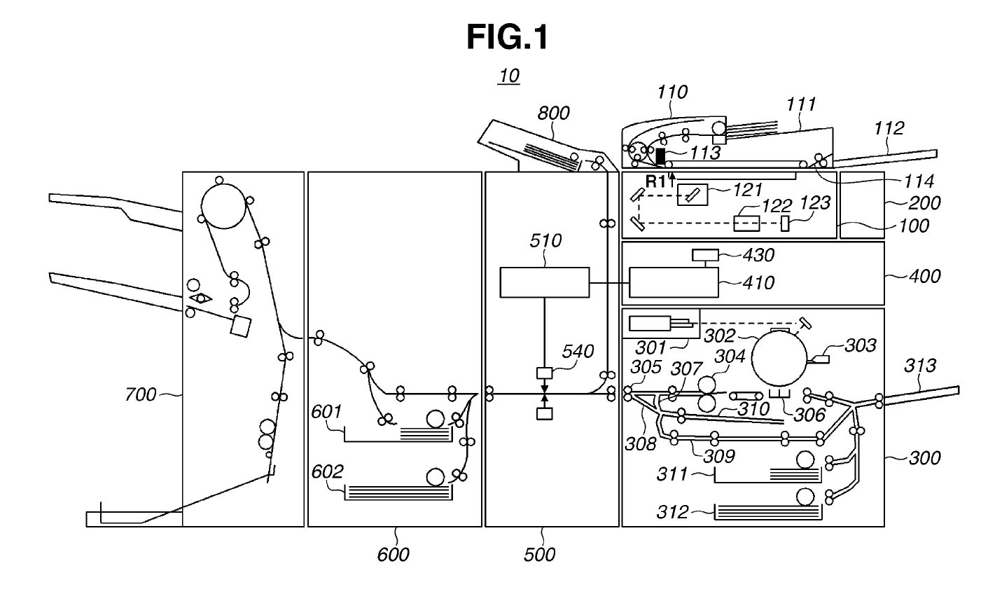

FIG. 1 illustrates a configuration of an inspection system which can be applied to an image forming apparatus according to an exemplary embodiment of the present invention.

FIG. 1 illustrates an inspection system 10 that serves as the image forming apparatus of the present invention. The inspection system 10 includes a document reading unit 100, an operation unit 200, a printer unit (printing unit) 300, a controller unit 400, an inspection unit 500, a stacker unit 600, a discharge unit (finisher) 700, and an inserter unit 800.

A document conveyance device 110 of the document reading unit 100 conveys documents set on a document tray 111 one by one from a first page onto a document positioning glass 114 via a bent path.

A document reading method in the document reading unit 100 is described below.

There are two methods for reading a one-sided document in the document reading unit 100. The first method is a document fixed-reading mode for reading a document by conveying and stopping a trailing edge of the document to a reading position R1 on the document positioning glass 114, and moving a scanner unit 121 left to right in the drawing. The second method is a document conveying reading mode for reading the document by conveying the document to the reading position R1 at a fixed reading speed, and fixing the scanner 121 at the reading position R1. These two methods for reading the one-sided document discharge the read document to a discharge tray 112.

For reading a two-sided document in the document reading unit 100, there is a method for reading a front side thereof by the scanner unit 121 and reading a backside thereof using an optical unit 113 disposed in the document conveyance device 110. The optical unit 113 includes an image sensor and a light source, which are not illustrated.

An image of the document read by an image sensor 123 via a lens 122 is processed to be stored in a storage device 430 in the controller unit 400, and transmitted to an exposure control unit 301 of the printer unit 300 via the controller unit 400. In the case of the two-sided document, the image read by the optical unit 113 is similarly processed to be stored in the storage device 430, and transmitted to the exposure control unit 301 of the printer unit 300 via the controller unit 400.

The exposure control unit 301 outputs a laser beam in response to an image signal. When a photosensitive drum 302 is irradiated with the laser beam, an electrostatic latent image is formed on the photosensitive drum 302. A developing device 303 develops the electrostatic latent image on the photosensitive drum 302. A transfer unit 306 transfers a developer on the photosensitive drum 302 to a sheet fed from one of cassettes 311 and 312 and a manual sheet feeding unit 313.

After the sheet having the developer transferred thereto has been guided to a fixing unit 304, the developer is fixed. The printer unit 300 guides the sheet passed through the fixing unit 304 from a path 307 to a path 310 by a flapper (not illustrated). After passing of a trailing edge of the sheet through the path 307, the printer unit 300 reverses the sheet by switchback to guide it from a path 308 to a discharge roller 305. The sheet, with a surface having the developer transferred thereto set down (face down), can accordingly be discharged from the printer unit 300 by the discharge roller 305. This processing is referred to as reverse discharge. Thus, discharging sheets face down enables image formation in correct order from a first page, for example, when images read from a plurality of documents by the document conveyance device 110 are printed.

When an image is formed on a hard sheet such as an overhead projection (OHP) sheet fed from the manual sheet feeding unit 313, the printer unit 300 discharges the sheet from the discharge roller 305 without guiding it to the path 307 while the surface having the developer transferred thereto is kept up (face up).

When images are formed on two sides of a sheet, the printer unit 300 guides the sheet from the fixing unit 304 to the path 307 and the path 310, reverses the sheet by the switchback immediate after passing of a trailing edge of the sheet through the path 307, and then guides the sheet to a two-side conveyance path 309 by the flapper (not illustrated). The transfer unit 306 transfers electrostatic latent images again to the sheet guided by the two-side conveyance path 309, and the fixing unit 304 fixes the images.

In such a loop of paths from the transfer unit 306 through the two-side conveyance path 309 back to the transfer unit 306, there are divided portions for a path length, a roller arrangement, and a drive system so that even five half-size sheets such as A4 or B5 inserted therein can be conveyed. In this processing, the sheets are discharged in order with odd pages set down. Hence, page orders can be matched during two-sided copying. Print outputs discharged from the discharge roller 305 are sent to the inspection unit 500.

In the inspection unit 500, first, the image reading unit 540 reads image data from a print surface of the print output printed by the printer unit 300. The image data (print product read data) read by the image reading unit 540 is transmitted to an inspection control unit 510 to be inspected for each page. The print output having its image data read is sent to the stacker unit 600, and then sent directly to the discharge unit 700 or to an OK tray 601 or an NG tray 602 based on an inspection result of the inspection control unit 510.

The user can select, by the operation unit 200, whether to discharge the print product sent to the OK tray 601 to the discharge unit 700 after all jobs are ended or to discharge it for each copy.

The print product sent from the stacker unit 600 to the discharge unit 700 is subjected to cutting, stapling, punching, or folding as set by the user via the operation unit 200, and then discharged.

The document sheet set in the inserter unit 800 is sent to the inspection unit 500, and discharged through the path to the discharge tray as described above.

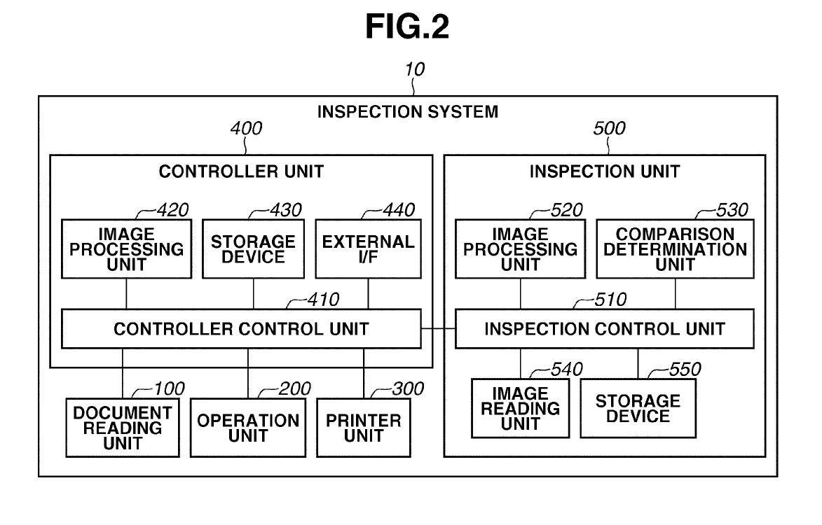

FIG. 2 illustrates an example of a schematic control configuration of the inspection system 10.

The document reading unit 100 reads and digitizes a document, and transmits read data to a controller control unit 410. The user can select a threshold value to determine a level of the inspection by the operation unit 200. The user can also set an inspection level checking mode described below by the operation unit 200. The printer unit 300 prints the data read by the document reading unit 100, data stored in the storage device 430, or data received by an external interface (I/F) 440.

The controller unit 400 includes the controller control unit 410, an image processing unit 420, the storage device 430, and the external I/F 440. The controller control unit 410 is connected to the document reading unit 100, the operation unit 200, the printer unit 300, the inspection unit 500, the image processing unit 420, the storage device 430, and the external I/F 440 to control various pieces of data.

The image processing unit 420 performs image processing on the data read by the document reading unit 100 or the data received by the external I/F 440 to transmit the data to the printer unit 300, and transmits the data to the controller control unit 410. The image processing unit 420 performs image processing on the data read by the document reading unit 100 or the image data received by the external I/F 440 to store the data as reference data (first image data) in the storage device 430. The reference data contains a plurality of pages in the case of a job including a plurality of pages.

The storage device 430 stores the data read by the document reading unit 100, the data received by the external I/F 440, or setting (a threshold value for inspection or setting of the inspection level checking mode) used in the inspection system 10. When a threshold value is set for each type of printing such as color printing or monochrome printing, each threshold value is stored. The external I/F 440 is connected to a PC or an image transmission apparatus via a universal serial bus (USB) cable, a public line, or a network to be able to transmit or receive image data.

The inspection unit 500 includes an inspection control unit 510, an image processing unit 520, a comparison determination unit 530, an image reading unit 540, and a storage device 550. The inspection control unit 510 is connected to the image processing unit 520, the comparison determination unit 530, the image reading unit 540, the storage device 550, and the controller control unit 410.

The inspection control unit 510 receives the reference data, the inspection threshold value or the setting of the inspection level checking mode from the controller control unit 410 to store them in the storage device 550. When the threshold value is set for each type of printing such as color printing or monochrome printing, each threshold value is stored.

The image reading unit 540 reads the sheet (print product) printed by the printer unit 300, and transmits the read data (print product read data) to the inspection control unit 510. The image processing unit 520 performs image processing of the print product read data read by the image reading unit 540 to be able to compare the data with the reference data.

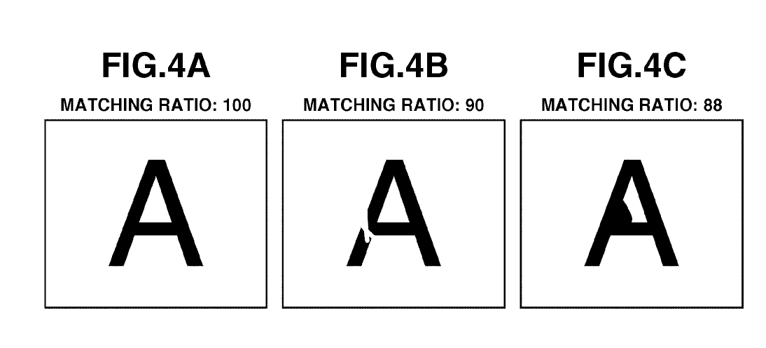

The comparison determination unit 530 compares the print product read data (second image data) read by the image reading unit 540 with the reference data (first image data) to calculate a matching ratio (detailed in FIG. 4). In this case, the inspection control unit 510 counts a page number of the print medium read by the image reading unit 540, and acquires the reference data from the storage device 430 according to the page number to transmit the reference data to the comparison determination unit 530.

The comparison determination unit 530 compares the inspection threshold value received from the controller control unit 410 and stored in the storage device 550 with the matching ratio to determine that an inspection result is OK (good print) or NG (not good or printing failure). When the threshold value is set for each type of printing such as color printing or monochrome printing, control is performed so that the controller control unit 410 and the inspection control unit 510 communicate with each other to use the threshold value corresponding to the type of printing.

The storage device 550 stores the reference data, the inspection threshold value, and the setting of the inspection level checking mode received from the controller control unit 410, and the image data (print product read data) read by the image reading unit 540. The storage device 550 also stores the matching ratio calculated by the comparison determination unit 530 and the inspection result.

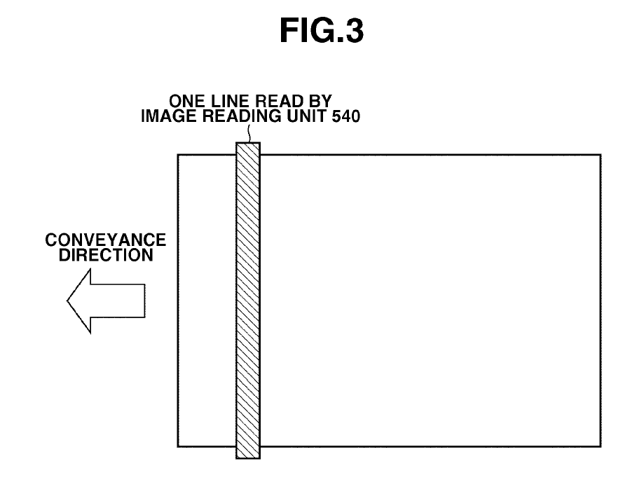

FIG. 3 illustrates an image of a one-line area where the image reading unit 540 of the inspection unit 500 reads a printed sheet (print product).

As illustrated in FIG. 3, the image reading unit 540 is a sensor (optical or otherwise) that reads all areas of a sheet width of the print product as the print product moves in the conveyance direction. Alternatively, the image reading unit 540 may also operate (by moving) in a manner similar to the scanning unit 121.

Each of FIGS. 4A to 4C illustrates a matching ratio between the data (print product read data) read by the image reading unit 540 and the reference data, and the inspection threshold.

The matching ratio between the print product read data and the reference data is calculated for each area described below. The comparison determination unit 530 compares the print product read data with the reference data for each area to calculate a difference between a printing position and a printing area, and calculates a matching ratio for each area based on the difference for each area. The above-described area can be an area determined by the comparison determination unit 530 based on a specific character size on the reference data (or the print product read data), or an area where the reference data (or the print product read data) is divided by i*j (i and j are predetermined integers).

FIG. 4A illustrates print product read data for a print-quality area of a matching ratio 100. As illustrated in FIG. 4A, when a printing position and a printing area of the print product read data of a certain area match expected printing position and printing area (a printing position and a printing area of the reference data in the same area) (difference 0%), a matching ratio of this area becomes “100”.

FIG. 4B illustrates print product read data for a print-quality area of a matching ratio 90. As illustrated in FIG. 4B, when a left side of the print product read data in a certain area is lost by 10%, the printing area becomes smaller by 10% than an expected printing area (the printing area of the reference data in the same area) (difference 10%), and hence a matching ratio of this area becomes “90”.

FIG. 4C illustrates print product read data for a print-quality area of a matching ratio 90. As illustrated in FIG. 4C, when the print product read data in a certain area is crushed by 12%, the printing area becomes larger by 12% than an expected printing area (the printing area of the reference data in the same area) (difference 88%), and hence a matching ratio of this area becomes “88”.

In other words, in a certain area, the print product read data is compared with the reference data and, when there is a difference of x % between a printing position and a printing area, a matching ratio of this area becomes “100−x”. When the matching ratio is below a set inspection threshold value, the comparison determination unit 530 determines that the area is an NG area (printing failure area). The comparison determination unit 530 determines a page having even one NG area to be an NG page. The inspection threshold value can be set for each type of printing such as color printing or monochrome printing, or the same threshold value can be used irrespective of types of printing.

After the matching ratios have been calculated for all the areas in the page, the comparison determination unit 530 transmits position information of all the areas, the matching ratios of all the areas, position information of the NG areas, and an inspection result of the page to the inspection control unit 510. The position information of the area can be any form of information as long as it enables checking of the position of the area, such as left upper coordinates or right lower coordinates.

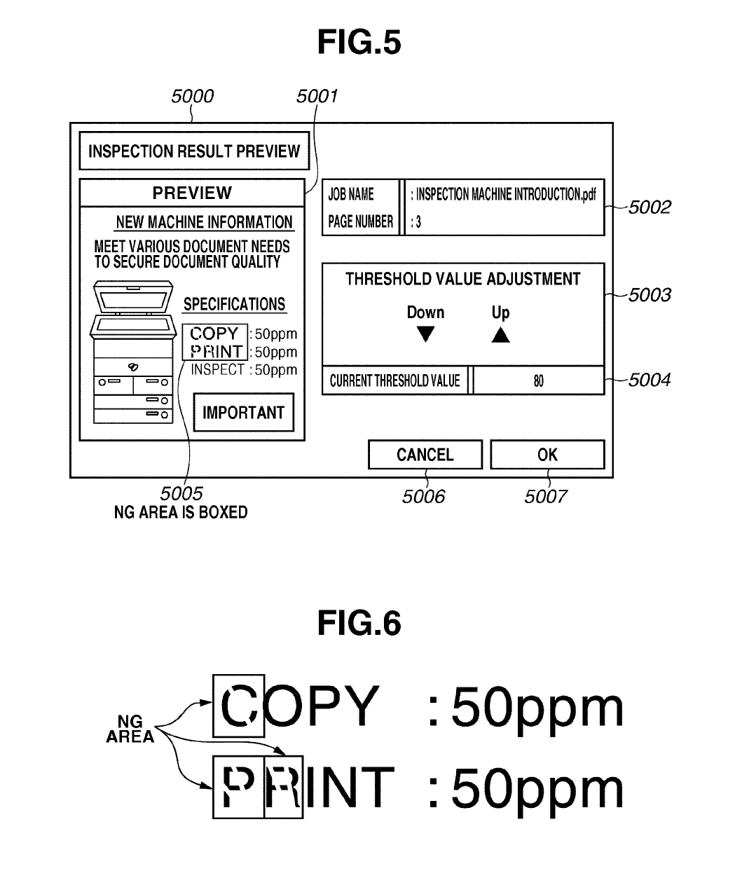

The inspection control unit 510 causes the storage device 550 to store the position information of all the areas, the matching ratios of all the areas, the position information of the NG areas, and the inspection result of the page. The inspection control unit 510 further transmits a job name, a page number, the print product read data, the position information of all the areas in the page, the matching ratios of all the areas in the page, and the position information of the NG areas to the controller control unit 410. The controller control unit 410 transmits these pieces of information to the operation unit 200. The operation unit 200 displays a screen illustrated in FIG. 5 using the job name, the page number, the print product read data, the position information of all the areas in the page, the matching ratios of all the areas in the page, the position information of the NG areas, and the inspection result of the page.

FIG. 5 to FIGS. 13A and 13B illustrate images of threshold value adjustment to determine inspection levels.

FIG. 5 illustrates an inspection result preview screen 5000. The screen 5000 is displayed on the operation unit 200 in the case of a job instructed from the operation unit 200, such as a copy job of printing, by the printer unit 300, document data read by the document reading unit 100. The screen 5000 is displayed on a display unit of a device that has transmitted a job to the external I/F 440 when the job is received via the external I/F 440, such as a print job of printing, by the printer unit 300, a print job received via the external I/F 440. For example, the screen 5000 is displayed on a monitor of a PC.

The displaying of the inspection result preview screen 5000 on a display unit of the operation unit 200 is described below. In this case, the inspection result preview screen 5000 is displayed on the display unit of the operation unit 200 under display control of a controller (not illustrated) of the operation unit 200.

The inspection result preview screen 5000 includes a preview area 5001 for displaying a preview of an inspection result. In the preview area 5001, the print product read data is displayed, and an “NG” area 5005 is boxed to be displayed on the print product read data (on the second image data).

The inspection result preview screen 5000 includes an area 5002 for displaying a job name and a page number of the print product displayed in the preview area 5001, a threshold value adjust button 5003 for adjusting a threshold value of a current inspection level, and an area 5004 for displaying the current threshold value. When the threshold value is set for each type of printing such as color printing or monochrome printing, a corresponding threshold value (threshold value actually used by the inspection unit 500 in the job) is displayed in the area 5004, and can be adjusted by the threshold value adjust button 5003. The inspection result preview screen 5000 further includes a cancel button 5006 and an OK button 5007.

FIG. 6 illustrates an enlarged portion including the boxed NG area illustrated in FIG. 5.

When an inspection result is NG, the operation unit 200 displays the screen 5000 based on information transmitted from the inspection unit 500 or the threshold value stored in the storage device 430. Particularly, the areas 5001 and 5005 are displayed based on the print product read data transmitted from the inspection unit 500 and the position information of the NG area. The area 5002 is displayed based on the job name and the page number.

When the user adjusts the threshold value by the threshold value adjust button 5003 (decreases the threshold value by a Down button or increases the threshold value by an Up button), the operation unit 200 displays the adjusted threshold value on the current threshold value 5004. The operation unit 200 compares the adjusted threshold value (changed threshold value) with the matching ratio of each area (redetermination), and controls the display to update the boxed data 5005 in the preview area 5001 with an area having the matching ratio below the adjusted threshold value set as an inspection NG area.

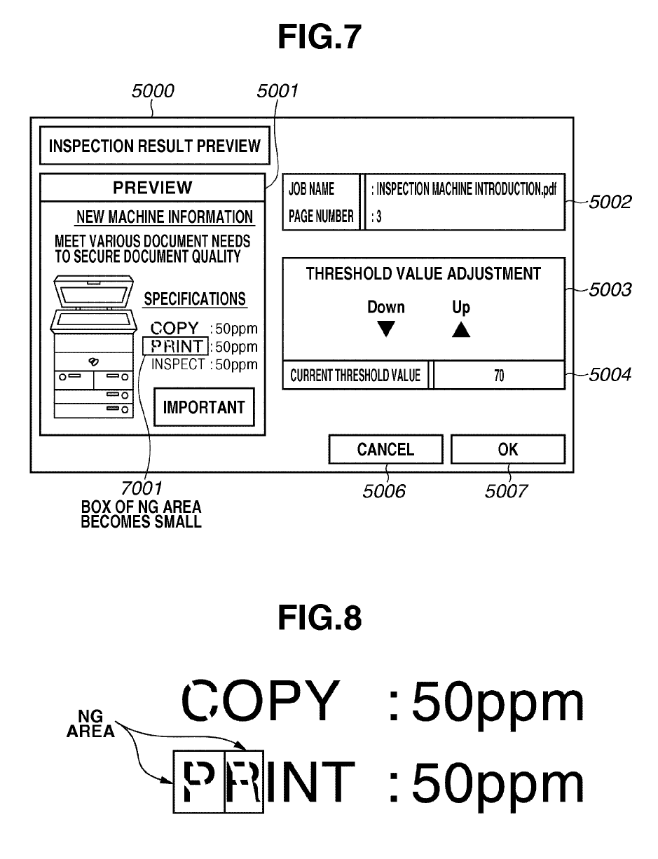

For example, when the user presses the Down button of the threshold adjust button 5003 to decrease the current threshold value “80” illustrated in FIG. 5 to “70”, the data inside the preview area 5001 is displayed again, and the box of the NG area becomes small as in the case of a box 7001 illustrated in FIG. 7.

FIG. 7 illustrates an example of the inspection result preview screen after the threshold value has been adjusted to “70”.

FIG. 8 illustrates an enlarged portion of the NG area illustrated in FIG. 5 after the threshold value has been adjusted to “70”.

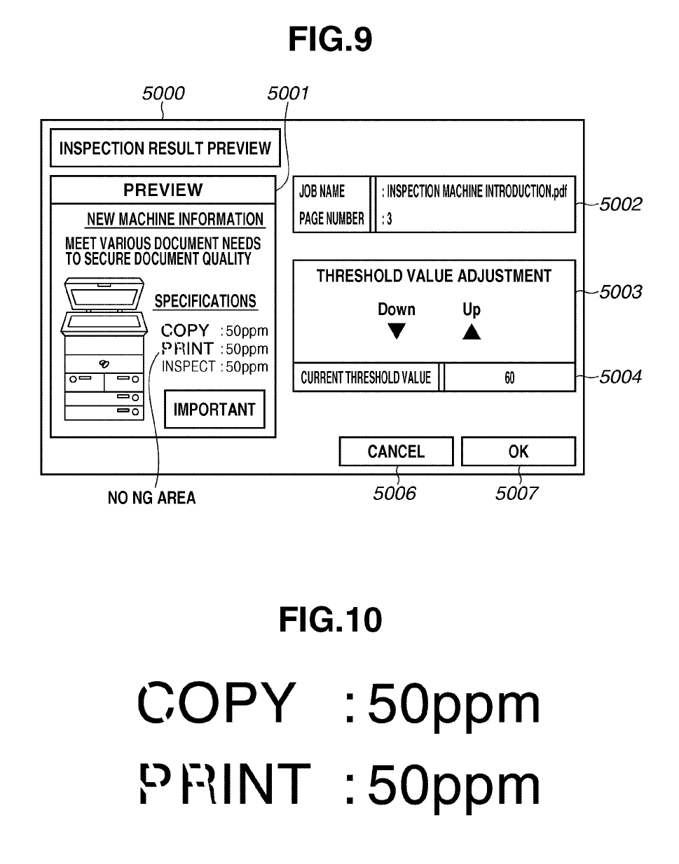

When the user further presses the Down button of the threshold value adjust button 5003 to decrease the current threshold value “70” illustrated in FIG. 7 to “60”, the data inside the preview area 5001 is displayed again, and the box of the NG area disappears as illustrated in FIG. 9. In other words, a page determined as the inspection result NG is changed to a page of inspection OK.

FIG. 9 illustrates an example of the inspection result preview screen after the threshold value has been adjusted to “60”.

FIG. 10 illustrates an enlarged portion of the NG area illustrated in FIG. 5 after the threshold value has been adjusted to “60”.

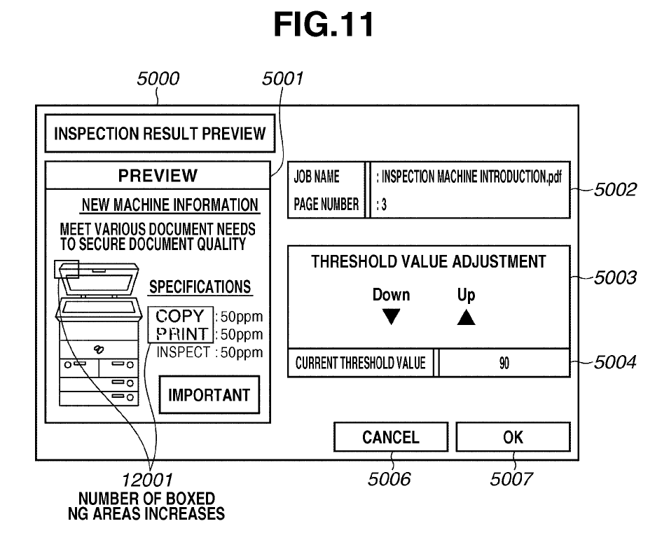

When the user presses the Up button of the threshold value adjust button 5003 to increase the current threshold value “80” illustrated in FIG. 5 to “90”, the data inside the preview area 5001 is displayed again, and an NG area is increased as illustrated in FIG. 11 to increase the number of boxes.

FIG. 11 illustrates an example of the inspection result preview screen after the threshold value has been adjusted to “90”.

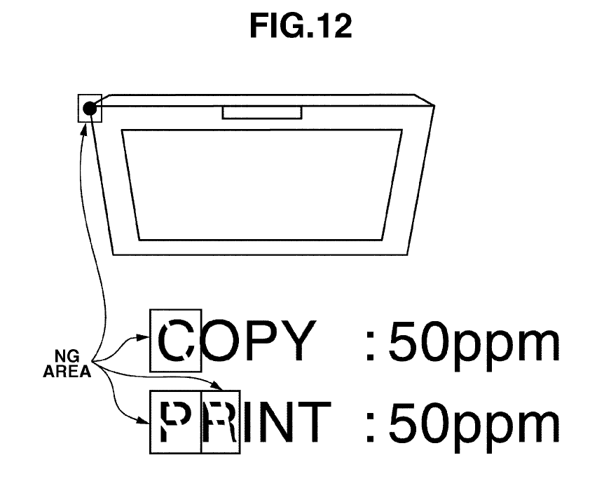

FIG. 12 illustrates an enlarged portion of the NG area illustrated in FIG. 11 after the threshold value has been adjusted to “90”.

In the present exemplary embodiment, a microprocessor in the operation unit 200 compares the matching ratio of each area with the changed threshold value to specify the inspection NG area. However, the inspection system can be configured to transmit the changed threshold value to the inspection unit 500, compare the matching ratio of each area with the changed threshold value in the inspection unit 500 to specify the inspection NG area, and transmit position information of the inspection NG area to the operation unit 200.

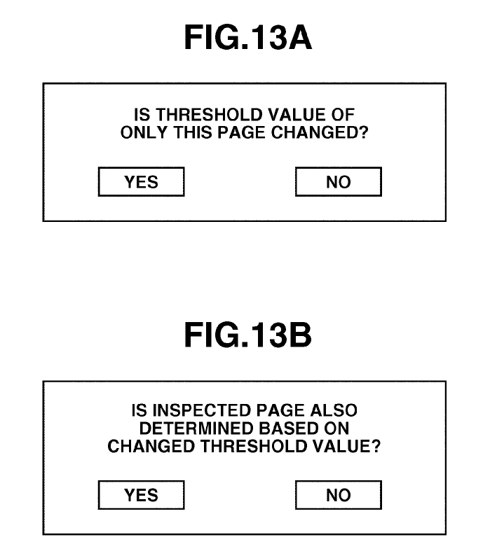

When the user presses the OK button 5007, changing of the threshold value is determined. In this case, when the threshold value has been adjusted lower as illustrated in FIG. 7 or FIG. 9, the operation unit 200 displays a screen illustrated in FIG. 13A to prompt the user to instruct whether to change the threshold value only for this page (not applied to the other pages). When the instruction from the user is received, the operation unit 200 notifies the inspection control unit 510 of, as information regarding threshold value changing, the changed threshold value and information as to whether the threshold value is changed only for this page.

When the user presses the OK button 5007, if the threshold value has been adjusted higher as illustrated in FIG. 11, the operation unit 200 displays a screen illustrated in FIG. 13B to prompt the user to instruct whether to execute determination for an already-inspected page by the changed threshold value. When the instruction from the user is received, the operation unit 200 notifies the inspection control unit 510 of, as information regarding threshold value changing, the changed threshold value and information as to whether to execute determination for the already-inspected page by the changed threshold value.

If the threshold value has not been changed when the user presses the OK button 5007, or when the user presses the cancel button 5006, the operation unit 200 notifies the inspection control unit 510 of, as information regarding threshold value changing, information indicating no threshold value changing.

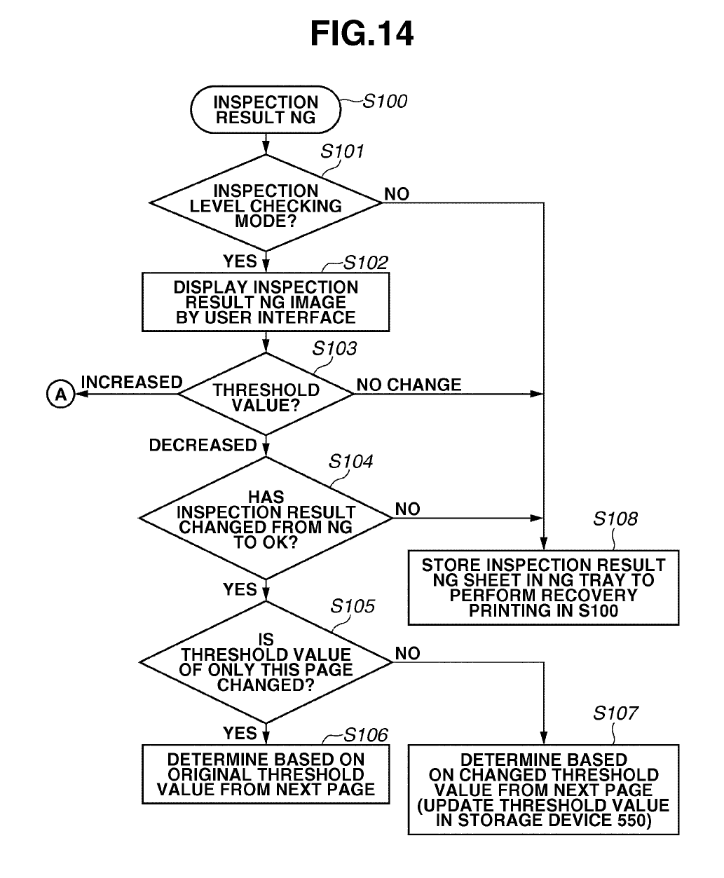

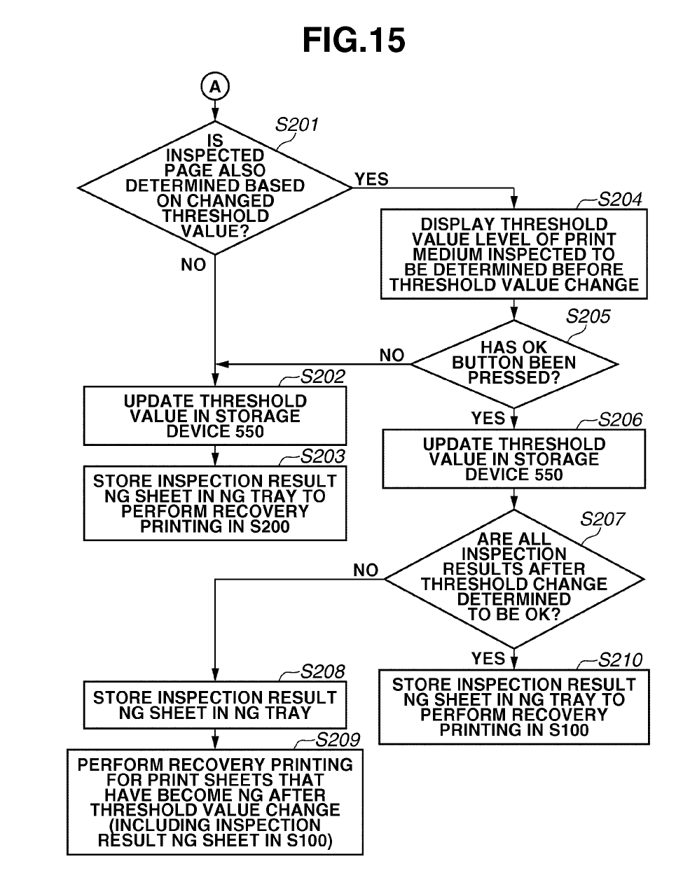

Referring to FIGS. 14 and 15, threshold value adjustment processing in the inspection system of the present invention is described.

FIGS. 14 and 15 are flowcharts illustrating examples of the threshold adjustment processing in the inspection system of the present exemplary embodiment. The processing of each flowchart is performed by a microprocessor (not illustrated) in the inspection control unit 510 based on a computer-readable program recorded in a read-only memory (ROM, not illustrated) in the inspection control unit 510. A threshold value described in the flowchart, when the threshold value is set for each type of printing such as color printing or monochrome printing, corresponds to a type of printing based on a job.

In step S100, the comparison determination unit 530 determines an inspection result to be NG. Then, the inspection control unit 510 executes control to stop conveyance of a print medium (hereinafter, sheet) (notifies the printer unit 300 of it via the controller control unit 410), and starts the processing of the flowchart.

First, in step S101, the inspection control unit 510 determines whether the inspection level checking mode has been set. The inspection level checking mode is set by the operation unit 200, and information as to presence of the inspection level checking mode is stored in the storage device 550.

When the inspection level checking mode is determined to have been set (YES in step S101), the inspection control unit 510 advances the processing to step S102.

In step S102, the inspection control unit 510 transmits information regarding the page of the NG inspection result to the operation unit 200 (user interface) via the controller control unit 410, and causes the operation unit 200 to display an image of the NG inspection result. The information regarding the page of the NG inspection result includes a job name, a page number, print product read data, position information of all areas in the page, matching ratios of all the areas in the page, or position information of an NG area.

The operation unit 200 displays the inspection result preview screen 5000 illustrated in FIG. 5, and displays a preview of the page of the NG inspection result. When the user presses the OK button 5007 or the cancel button 5006 on the inspection result preview screen 5000, the operation unit 200 notifies the inspection control unit 510 of the information regarding the above-described threshold value changing via the controller control unit 410.

In step S103, the inspection control unit 510 determines, based on the information regarding the threshold value changing notified from the operation unit 200, whether the user has decreased, increased, or not changed the threshold value.

When it is determined that the “threshold value is decreased” by the user (DECREASED in step S103), the inspection control unit 510 advances the processing to step S104.

In step S104, the inspection control unit 510 determines, based on the information regarding the threshold value changing notified from the operation unit 200, whether the inspection result has been changed from NG to OK. More specifically, the inspection control unit 510 determines whether the inspection result has been changed from NG to OK by comparing the changed threshold value with the matching ratios of all the areas in the page stored in the storage device 550.

When it is determined that the inspection result has been changed from NG to OK (the matching ratios of all the areas are equal to or more than the changed threshold value) (YES in step S104), the inspection control unit 510 advances the processing to step S105.

In step S105, the inspection control unit 510 determines whether the threshold value changing is the “threshold value changing only for this page”. When it is determined that the threshold value changing is the “threshold value changing only for this page” (YES in step S105), the inspection control unit 510 advances the processing to step S106.

In step S106, the inspection control unit 510 executes control to make determination for a next page and after based on the original threshold value without updating the threshold value stored in the storage device 550, and to resume sheet conveyance to process the next page.

On the other hand, when it is determined that the threshold value changing is not the threshold value changing only for this page (NO in step S105), the inspection control unit 510 advances the processing to step S107.

In step S107, the inspection control unit 510 updates the threshold value stored in the storage device 550 by the new changed threshold value received from the operation unit 200. The inspection control unit 510 further executes control to determine inspection by the changed threshold value for the next page and after, and to resume sheet conveyance to process the next page.

When it is determined that the inspection level checking mode has not been set (NO in step S101), there is no threshold value changing (NO in step S103), or the inspection result has not been changed from NG to OK (No in step S104), the control unit 510 advances the processing to step S108.

In step S108, the inspection control unit 510 controls the stacker unit 600 to store the print product (sheet) corresponding to the page of the NG inspection result determined in step S100 in the NG tray 602. The inspection control unit 510 notifies the controller control unit 400 of recovery printing to print the print product stored in the NG tray 602 again.

The controller control unit 400 that has received the notification executes control to perform the recovery printing. When the recovery printing is OK, the controller control unit 400 executes control to proceed to a next page.

In step S103, when it is determined that “the threshold value is increased” by the user (INCREASED in step S103), the inspection control unit 510 advances the processing to step S201 in FIG. 15.

In step S201 illustrated in FIG. 15, the inspection control unit 510 determines, based on the information regarding the threshold value changing notified from the operation unit 200, whether to “determine even an already-inspected page by the changed threshold value”.

When it is determined that the already-inspected page is not determined by the changed threshold value (determination is executed from the next page by the changed threshold value) (NO in step S201), the inspection control unit 510 advances the processing to step S202.

In step S202, the inspection control unit 510 updates the threshold value stored in the storage device 550 by the changed threshold value.

In step S203, the inspection control unit 510 controls the stacker unit 600 to store the print product corresponding to the page of the NG inspection result determined in step S100 in the NG tray 602. The inspection control unit 510 notifies the controller control unit 400 of recovery printing to print the print product stored in the NG tray 602 again.

The controller control unit 400 that has received the notification controls the printer unit 300 to perform the recovery printing of the print product including the page of the NG inspection result. When the recovery printing is OK, the controller control unit 400 executes control to proceed to the next page.

On the other hand, if it is determined that “the already-inspected page is also determined by the changed threshold value” (YES in step S201), the inspection control unit 510 advances the processing to step S204.

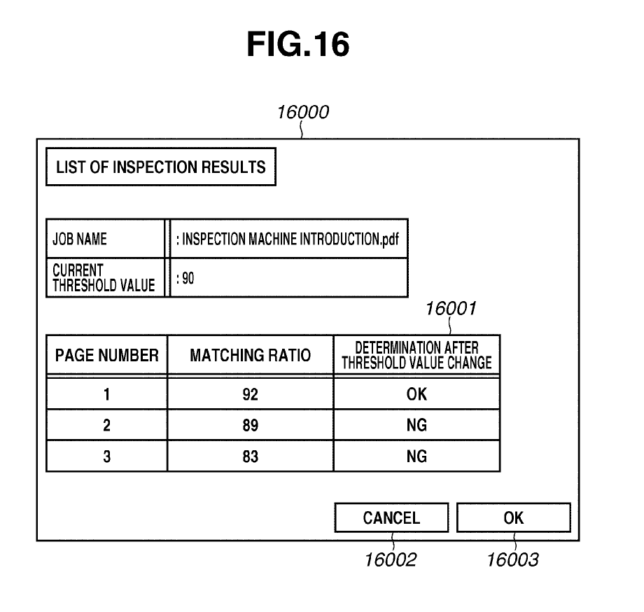

In step S204, the inspection control unit 510 generates a list of inspection determination results illustrated in FIG. 16 by using the changed threshold value and the information stored in the storage device 550, and controls the operation unit 200 to display the list.

More specifically, the inspection control unit 510 determines the page that has been inspected by the threshold value before the change by the changed threshold value again, and generates, to display a list of the redetermination results, the list of inspection determination results illustrated in FIG. 16. The inspection control unit 510 then transmits the generated list of inspection determination results to the operation unit 200 (user interface) via the controller control unit 410, and the operation unit 200 displays the list of inspection determination results as illustrated in FIG. 16.

FIG. 16 illustrates an inspection determination result list screen for displaying a matching ratio (minimum value of the matching ratio of each area) of a print medium determined for inspection before the threshold value change and the list of inspection determination results after the threshold value change.

The operation unit 200 displays the inspection determination result list screen 16000 illustrated in FIG. 16. The inspection determination result list screen 16000 includes a matching ratio (the minimum value of the matching ratio in page) of each page determined for inspection by the threshold value before the change, and a list 16001 of the inspection determination results by the changed threshold value (an inspection determination result list) with respect to each page determined for inspection by the threshold value before the change. The inspection determination result list 16001 includes the inspection determination result of the sheet determined to be NG in step S101.

When the user presses a cancel button 16002 on the inspection determination result list screen 16000, the operation unit 200 notifies the inspection control unit 510 of information indicating the pressing of the cancel button 16002. On the other hand, when the user presses an OK button 16003 on the inspection determination result list screen 16000, the operation unit 200 notifies the inspection control unit 510 of information indicating the pressing of the OK button 16003.

In step S205, the inspection control unit 510 determines whether a notification about pressing of the OK button 16003 has been received. When it is determined that the notification about pressing of the OK button 16003 has not been received (i.e., the cancel button 16002 has been pressed, NO in step S205), the inspection control unit 510 advances the processing to step S206.

On the other hand, it is determined that the notification about pressing of the OK button 16003 has been received (YES in step S205), the inspection control unit 510 advances the processing to step S206.

In step S206, the inspection control unit 510 updates the threshold value stored in the storage device 550 by the changed threshold value.

In step S207, the inspection control unit 510 determines whether all inspection results by the changed threshold value are OK for respective pages determined for inspection by the threshold value before the change (not including the pages determined to be NG inspection results in step S101). When there is a page determined to be NG as a result of determination by the changed threshold value (NO in step S207), the inspection control unit 510 advances the processing to step S208.

In step S208, the inspection control unit 510 controls the stacker unit 600 to store the print product corresponding to the page of the NG inspection result determined in step S100 in the NG tray 602.

In step S209, the inspection control unit 510 notifies the controller control unit 400 of recovery printing to print the print product corresponding to the page determined to be NG in inspection by the changed threshold value again. In this case, the inspection control unit 510 also instructs the controller control unit 400 to perform recovery printing for the print product determined to be NG in inspection in step S100.

The controller control unit 400 that has received the notification executes control to perform the recovery printing. In the example illustrated in FIG. 16, a second page and a third page (pages determined to be NG in step S100) are subjected to the recovery printing in step S209. When the recovery printing is all OK, the controller control unit 400 executes control to proceed to a next page.

Oh the other hand, in step S207, when it is determined that all inspection results by the changed threshold value are OK for the respective pages determined for inspection by the threshold value before the change (YES in step S207), the inspection control unit 510 advances the processing to step S210.

In step S210, the inspection control unit 510 controls the stacker unit 600 to store the print product corresponding to the page of the NG inspection result determined in step S100 in the NG tray 602. The inspection control unit 510 notifies the controller control unit 400 of recovery printing to print the print product stored in the NG tray 602 again.

The controller control unit 400 that has received the notification executes control to perform the recovery printing. When the recovery printing is OK, the controller control unit 400 executes control to proceed to a next page.

In other words, in steps S204 to S210, the inspection control unit 510 determines the pages that have already been inspected by the threshold value before the change by the changed threshold value again, and performs control to execute redetermination to reprint the print medium including pages re-determined to be NG.

As described above, the image forming apparatus according to the present exemplary embodiment can inspect, even when the print product from the printer unit becomes a failure, the failure by the inspection unit, and display a defective image of the actual print product on the display unit of the operation unit. The user can adjust the inspection threshold value while viewing the image.

Thus, the user can easily adjust the threshold value corresponding to a job while checking an actual print image of a portion determined to be a printing failure by actual inspection by the operation unit.

Even in the case of an image forming apparatus that includes a variety of inspection levels (e.g., threshold value is set for each type of printing such as color or monochrome printing), the user can easily adjust a level of a corresponding threshold value to a desired level matching a printing purpose without being aware of the type of the threshold value.

As a result, discarding of sufficient-quality print products processed to be printing failures more than necessary, and processing, as good printing, of print products of quality to be discarded as printing failures can be suppressed.

In the above-described exemplary embodiment, the inspection result preview screen is displayed when the inspection result is NG. However, irrespective of NG or OK inspection results, the inspection result preview screen can be displayed for all the pages.

Further in the above-described exemplary embodiment, the inspection result preview screen is displayed in the boxed form of the NG area (clarified by the box). However, any form other than the clarification form by the box can be employed as long as it can identify the NG area.

For example, the NG area can be displayed with hatching, or the NG area can be clarified by color changing such as a form of changing a color of the NG area. In the case of the form of changing the color of the NG area, the color can be a color not used for the page of NG inspection, or a preset specific color. For the color of the NG area, the inspection result preview screen may display that a place displayed by the color is the NG area.

Configurations and contents of various data pieces are not limited to those described above. Needless to say, various configurations and contents can be employed according to use and purposes.

The exemplary embodiment has been described. However, the present invention can be applied in a variety of forms such as a system, an apparatus, a method, a program, and a storage medium. More specifically, the invention can be applied to a system that includes a plurality of devices, or an apparatus that includes one device.

Aspects of the present invention can also be realized by a computer of a system or apparatus (or devices such as a central processing unit (CPU) or a micro processing unit (MPU)) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-166863 filed Jul. 26, 2010, which is hereby incorporated by reference herein in its entirety.

What is claimed is:

1. A printing apparatus comprising:
a printing unit configured to execute printing based on first image data;
a reading unit configured to read a sheet on which the printing has been executed to generate second image data;
a determination unit configured to determine whether a printing failure has occurred on the sheet by comparing the first image data with the second image data;
a display unit configured to display a result of determination executed by the determination unit; and
a changing unit configured to change a determination method used for determining whether the printing failure has occurred by the determination unit after the display unit has displayed the result of the determination,
wherein the determination unit executes, if the changing unit changes the determination method, determination again based on the changed determination method, and
the display unit displays a result of the determination executed by the determination unit using the changed determination method.

2. The printing apparatus according to claim 1, wherein the display unit displays an area of the sheet on which the printing failure has occurred to be recognizable by a user.

3. The printing apparatus according to claim 1, wherein the determination unit compares a matching ratio between the first image data and the second image data with a threshold value.

4. The printing apparatus according to claim 3, wherein the changing unit changes the threshold value.

5. The printing apparatus according to claim 1, further comprising a setting unit configured to set, if the changing unit changes the determination method, whether to use the changed determination method for a next sheet and after,
wherein if the setting units sets use of the changed determination method for the next sheet and after, the determination unit determines whether printing failures have occurred on the next sheet and after based on the changed determination method, and
if the setting unit sets non-use of the changed determination method for the next sheet and after, the determination unit determines whether printing failures have occurred on the next sheet and after based on the determination method before the change.

6. The printing apparatus according to claim 1, wherein the determination unit executes, if the changing unit changes the determination method, determination again for a page for which the determination unit has already executed determination using the changed determination method; and
the display unit displays a result of the determination executed using the changed determination method for the page for which the determination unit has already executed determination.

7. The printing apparatus according to claim 1, wherein the printing unit prints the sheet again which is determined by the determination unit that a printing failure has occurred thereon.

8. A method for controlling a printing apparatus, the method comprising:
executing printing based on first image data;
reading a sheet on which the printing has been executed to generate second image data;
determining whether a printing failure has occurred on the sheet by comparing the first image data with the second image data;
displaying a result of the determination;
changing a determination method used for determining whether the printing failure has occurred after the result of the determination is displayed; and
executing, if the determination method is changed, determination again based on the changed determination method and displaying a result of the determination executed by using the changed determination method.

9. A storage medium that stores a program for causing a computer to execute the method according to claim 8.
